(19) United States
(12) Patent Application Publication
(10) Pub. No.: US 2021/0295145 A1
(43) Pub. Date: Sep. 23, 2021

(54) DIGITAL-ANALOG HYBRID SYSTEM ARCHITECTURE FOR NEURAL NETWORK ACCELERATION

(71) Applicant: MENTIUM TECHNOLOGIES INC., Santa Barbara, CA (US)

(72) Inventor: Farnood Merrikh BAYAT, Goleta, CA (US)

(73) Assignee: MENTIUM TECHNOLOGIES INC., Santa Barbara, CA (US)

(21) Appl. No.: 17/210,050

(22) Filed: Mar. 23, 2021

Related U.S. Application Data
(60) Provisional application No. 62/993,548, filed on Mar. 23, 2020.

(51) Int. Cl. G06N 3/063; G06N 3/04

(52) U.S. Cl. CPC G06N 3/0635; G06N 3/04

(57) ABSTRACT

A hybrid accelerator architecture consisting of digital accelerators and in-memory computing accelerators. A processor managing the data movement may determine whether input data is more efficiently processed by the digital accelerators or the in-memory computing accelerators. Based on the determined efficiencies, input data may be distributed for processing to the accelerator determined to be more efficient.

### CROSS-REFERENCE TO A RELATED APPLICATION

This patent application claims the benefit of and priority to U.S. Provisional App. No. 62/993,548, filed Mar. 23, 2020, which is incorporated by reference in the present disclosure in its entirety for all that it discloses.

### BACKGROUND

Executing machine learning and deep neural network algorithms in the cloud has lots of disadvantages like high latency, privacy concerns, bandwidth limitations, high power requirements, etc. which makes the execution of these algorithms at the edge very preferable. Due to the high fault tolerance capability of neural network-based systems, the internal computations of these algorithms can be executed at lower precisions allowing both analog or In-Memory Computing (IMC) and digital accelerators to be used for the acceleration of AI algorithms at the edge. However, since when dealing with edge computing, the most limited resource is power, the main goal in designing an edge accelerator is to keep the power consumption as low as possible.

While most AI accelerators are designed with digital circuits, they usually have low efficiencies at the edge mainly due to the problem known as memory bottleneck. In these accelerators, since most of the network parameters cannot be stored on the chip, these parameters have to be fetched from an external memory which is a very power-hungry operation. The efficiency of these accelerators may be improved if the number of network parameters can be reduced so they can fit in the on-chip memory, for example, by network pruning or compression.

In-memory computing accelerators can also be used to perform the computation of AI algorithms like deep neural networks at the edge. Despite having limited precision of computation, these accelerators usually consume much less power compared to digital accelerators by not moving network parameters around the chip. In these accelerators, computations are done using the same physical device storing the network parameters. However, the efficiency of these accelerators may reduce when implementing specific types of neural networks due to the large overhead of Analog-to-Digital Converters (ADC) and Digital-to-Analog Converters (DAC).

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In one embodiment, a computer-implemented method for accelerating computations in applications is disclosed. At least a portion of the method may be performed by a computing device comprising one or more processors. The computer-implemented method may include evaluating input data for a computation to identify first data and second data. The first data may be data that is determined to be more efficiently processed by a digital accelerator and the second data may be data that is determined to be more efficiently processed by an in-memory computing accelerator. The computer-implemented method may also include sending the first data to at least one digital accelerator for processing and sending the second data to at least one in-memory computing accelerator for processing.

In some embodiments, the computation may be evaluated for sensitivity to precision. Input data that is determined to require a high level of accuracy may be identified as first data and input data that is determined to tolerate some imprecision may be identified as second data.

In some embodiments, the input data may include network parameters and activations of a neural network and the computation may relate to specific layers of the neural network to be implemented. The evaluating of input data may include calculating a number of network parameters in each layer of the neural network. The layers of the neural network having a larger number of network parameters may be determined to be second data and the layers of the neural network having a smaller number of network parameters may be determined to be first data. In other embodiments, the evaluating of input data may include calculating a number of times that network parameters are reused in each layer of the neural network. The layers of the neural network that have a high weight of network parameter reuse may be determined to be first data and the layers of the neural network that have a low weight of network parameter reuse may be determined to be second data. In other embodiments, the at least one digital accelerator and the at least one in-memory computing accelerator may be configured to implement the same layer of the neural network.

In some embodiments, the at least one digital accelerator may include a first digital accelerator located on a first hybrid chip and a second digital accelerator located on a second hybrid chip. The at least one in-memory computing accelerator may include a first in-memory computing accelerator located on the first hybrid chip and a second in-memory computing accelerator located on the second hybrid chip. In some embodiments, the first and second hybrid chips may be connected together by a shared bus or through a daisy chain connection.

In some embodiments, one or more non-transitory computer-readable media may include one or more computer-readable instructions that, when executed by one or more processors of a remote server device, cause the remote server device to perform a method for accelerating computations in applications.

In some embodiments, a remote server device may include a memory storing programmed instructions, at least one digital accelerator, at least one digital accelerator, and a processor that is configured to execute the programmed instructions to perform a method for accelerating computations in applications.

The object and advantages of the embodiments will be realized and achieved at least by the elements, features, and combinations particularly pointed out in the claims. Both the foregoing summary and the following detailed description are exemplary and are not restrictive of the invention as claimed.

### BRIEF DESCRIPTION OF THE DRAWINGS

Example embodiments will be described and explained with additional specificity and detail through the use of the accompanying drawings in which:

FIG. 1 illustrates an exemplary system architecture of digital-IMC hybrid accelerator with both digital and in-memory computing accelerators working together to execute AI or deep neural network algorithms;

FIG. 2 illustrates an exemplary method for distributing the computational load between digital and in-memory computing accelerators;

FIG. 3 illustrates an example of a system in which a single main processor/controller is controlling and feeding multiple hybrid accelerator chips using a bus shared between all modules;

FIG. 4 illustrates an example of a system in which a single main processor/controller is controlling and feeding multiple hybrid accelerator chips which are connected together in a daisy chain fashion; and

FIG. 5 illustrates an example of scaling up a system based on hybrid accelerators in which one of the hybrid accelerator acts as a master controller/processor controlling the other slave hybrid accelerator modules/chips.

### DETAILED DESCRIPTION

This disclosure provides a hybrid accelerator architecture consisting of a plurality of digital accelerators and a plurality of in-memory computing accelerators. The computing system may also include an internal or external controller or processor managing the data movement and scheduling the operations within the chip. The hybrid accelerator may be used to accelerate data or computationally intensive algorithms like machine learning programs or deep neural networks.

In one embodiment, a low-power hybrid accelerator architecture is provided to accelerate the operations of machine learning and neural networks. The architecture may include a plurality of digital accelerators and a plurality of in-memory computing accelerators. The architecture may also include other modules necessary for the proper operation of the system such as internal or external memory, interfaces, NVM memory module to store network parameters, processor or controller, digital signal processor, etc.

The internal or external master controller may send the data to one or multiple accelerators to get processed. The results of the computation may be received by the controller or written directly to the memory.

In some embodiments, the digital accelerators may be designed to deliver high efficiency when the number of network parameters is small or when the number of times each set of network parameters reused is large. In these cases, the network parameters stored within the accelerator may be used to process a large amount of input data before being replaced by the next set of network parameters.

In some other embodiments, the in-memory computing accelerators may be designed to deliver high efficiency when the number of network parameters is large. In these cases, the network parameters of the specific layer of the network may be stored within one or more in-memory computing accelerators by programming them once and then these accelerators may be used for subsequent implementation of these specific layers of the network.

In some embodiments, the main software or controller may distribute the workloads of the neural networks between the digital and in-memory computing accelerators in such a way that the system reaches higher efficiency while consuming the lowest power. Layers with small numbers of parameters or large weight reuse may be mapped to digital accelerators while layers with large numbers of parameters may be mapped to in-memory computing accelerators. In each category, i.e. digital or in-memory computing accelerators, multiple accelerators may be used in parallel to improve the system throughput.

In some embodiments, digital and in-memory computing accelerators may be pipelined together to increase the throughput of the hybrid system.

In some other embodiments, layers of the network sensitive to the accuracy of the computation may be implemented in the digital accelerators while layers which can tolerate imprecise computation may be mapped to the in-memory computing accelerators.

In some embodiments, multiple hybrid accelerators may be connected together for example by using a shared bus or through the daisy chain connection to increase the processing power and throughput of the overall system. A separate host processor or one of the hybrid accelerators may act as a master controller to manage the whole system.

Any digital accelerator within a plurality of digital accelerators may receive data from the processor, internal or external memory or buffers using a shared or its own dedicated bus. The digital accelerator may also receive another set of data from internal or external memory which may be the network parameters required for the execution of the computations for the specific layer of the neural network the accelerator is implementing. The accelerator may then perform the computation specified by the controller on the inputted data using the weights fed into the accelerator and send back the result to the external or internal memory or buffers.

Whenever the number of parameters of a neural network is small, the parameters may be transferred to the buffers inside the digital accelerator once. Then the accelerator may use the same stored parameters to process a large batch of incoming data like the feature maps of neural network layers. The possibility of reusing the same parameters for a large number of input data may increase the accelerator and system efficiency by eliminate the frequent power-hungry transfer of network parameters between the memory and the accelerator. In this case, the power consumed in the system may be the sum of power consumed to transfer input data to the accelerator and the power consumed by the accelerator to perform the computations. The power consumed to transfer the network parameters to the accelerator may be neglected since the parameters may be used to process large number of input data.

The efficiency of the digital accelerator may drop if the number of networks parameters gets large compared to the number of input data or the number of times the accelerator reuses each set of parameters after being transferred to the accelerator. In this situation, the wasted power consumed to transfer network parameters from the memory to the accelerator gets comparable or even larger than the sum of powers consumed to transfer the input data to the accelerator and to perform the computations within the accelerator. The efficiency may drop fast if the network parameters are stored on an external memory as accessing external memory is more power hungry than accessing internal memories like SRAM.

Any in-memory computing accelerator (either digital, analog or mixed signal) within a plurality of in-memory computing accelerators may receive data from the processor, internal or external memory or buffers using a shared or its own dedicated bus. The in-memory computing accelerator may also store in itself network parameters (either through on-time programming or infrequent refreshing) required for the execution of the computations for the specific layer of the neural network the accelerator is implementing. The accelerator may then perform the computation specified by the controller on the inputted data using the weights fed into the accelerator and send back the result to the external or internal memory or buffers.

Whenever the number of parameters of a neural network is large, the in-memory computing accelerator may be programmed with these network parameters once. Then the accelerator may use the same stored parameters to process a large batch of incoming data like the feature maps of neural network layers. The possibility of reusing the large number of parameters for a multiple input data may increase the accelerator and system efficiency by eliminate the frequent power-hungry transfer of network parameters between the memory and the accelerator. In this case, the power consumed in the system may be the sum of power consumed to transfer input data to the accelerator and the power consumed by the accelerator to perform the computations. The power consumed to transfer the network parameters to the in-memory computing accelerator may be neglected since the parameters may be transferred very infrequently and the parameters may be used in the accelerator to process large number of input data.

The efficiency of the in-memory computing accelerator may drop if the number of networks parameters is small. In this situation, the power consumed by the peripheral circuits inside the in-memory computing accelerator like ADC, DAC, etc. may become much larger than the sum of powers consumed to transfer the input data to the accelerator and to perform the computations within the accelerator. The smaller the number of parameters, the lower may be the efficiency of computing in the in-memory computing accelerator.

The software program and/or the main controller/processor may distribute the workload of one layer of neural network between one or multiple digital or IMC accelerators. For layers of neural networks where the number of parameters is small or when the same parameters are used to process large number of activation data, the controller may execute the layer within the digital accelerators to have the maximum efficiency and the lowest power consumption. If the number of parameters is larger than what it can fit inside a single digital accelerator or in order to speed up the execution of the layer, the controller may use two or more digital accelerators in parallel to execute the layer.

In some embodiments, multiple digital accelerators may be used to execute the exact same operation to speed up the execution of single operation on large number of activations. In other embodiments, a single large layer may be broken down into multiple parts where each section is mapped and implemented in one of the digital accelerators.

For layers of neural networks where the number of parameters is large, the controller may store network parameters inside an in-memory computing accelerator and use the accelerator to execute the layer to maximize the system efficiency while lowering its power consumption. If the number of parameters is smaller than the whole capacity of the in-memory computing accelerator, multiple layers may be mapped to the same accelerators. On the other hand, if the number of parameters is larger than what it can fit inside a single in-memory computing accelerator or in order to speed up the execution of the layer, the controller may use two or more in-memory computing accelerators in parallel to execute the layer.

In some embodiments, multiple in-memory computing accelerators may be used to execute the exact same operation to speed up the execution of single operation on large number of activations. In other embodiments, a single large layer may be broken down into multiple parts where each section is mapped and implemented in one of the in-memory computing accelerators.

To implement a whole neural network consisting of multiple layers with different sizes and types, the controller may distribute the computations and layers between digital and in-memory computing accelerators based on the specifications of layers to minimize the total power consumed by the system. For example, the host controller may map the layers of network with small number of parameters but large number of activation pixels (like the first layers of the convolutional networks) to one or multiple digital accelerators while the layers with large number of parameters (like fully-connected or last convolutional layers) are mapped to one or multiple in-memory computing accelerators.

In some embodiment, the hybrid accelerator may also include other module like digital signal processor, external interfaces, flash memories, SRAMs, etc. which are required for the proper operation of the accelerator.

Different technologies and architectures may be used to implement the digital accelerators, including but not limited to systolic arrays, near-memory computing, GPU-based or FPGA-based architectures, etc.

Different technologies and architectures may be used to implement the in-memory computing accelerators. These technologies may include but not limited to analog accelerators based on memory device technologies like flash transistors, RRAM, MRAM, etc. or they may even be based on digital circuits using digital memory elements like SRAM cells or latches.

In some embodiments, the digital and in-memory computing accelerators may have been fabricated with the same technology on a same die. In other embodiments, in-memory computing and digital accelerators may have been fabricated with different technologies and connected externally. For example, digital accelerators may be fabricated using 5 nm process while the in-memory computing accelerators may be fabricated at 22 nm.

In some embodiments where the host processor or controller has an integrated and powerful accelerator, a hybrid system may be created by connecting the host processor to a plurality of in-memory computing accelerators internally or externally.

In some embodiments, each of these accelerators may communicate with the controller or memories through a shared bus. In other embodiments, there may be two shared buses, one for the digital accelerators and another one for the in-memory computing accelerators. In yet another set of embodiments, each individual accelerator may communicate with the controller or the memory through its own bus.

In some embodiments, all accelerators in either the digital or in-memory computing category may have the same sizes. In other embodiments, different accelerators may have different sizes so they can implement different layers of neural networks with different speed and efficiency.

Since neural networks are not very sensitive to the accuracy of computation, different digital or in-memory computing accelerators may perform the computations at different precisions. In some embodiments, these accelerators may be designed such a way that their accuracies may be adjusted on the fly based on the sensitivity of the layer they are implementing to the accuracy of the computation. In other embodiments, layers sensitive to the accuracy of computation may be implemented in digital accelerators while in-memory computing accelerators may be used to execute layers which can tolerate imprecise calculations.

In some embodiments, the software or the main controller may use both digital and in-memory computing accelerators in parallel to deliver higher throughput. These accelerators may work together to implement the same layer of the network or they may be pipelined to implement different layers of a network.

In some embodiments, the hybrid accelerator architecture may be used to accelerate computations in applications other than machine learning and neural networks.

In some embodiments, the hybrid processing accelerator may be scaled up by connecting multiple of these hybrid accelerators together. Hybrid accelerators may be connected together through a shared bus or through a daisy chain wiring. There may be a separate host processor controlling the hybrid accelerators and the data movements or one of the hybrid accelerators may act as a master controlling the other slave accelerators.

Each of these hybrid accelerators may have its own controller/processor allowing it to work as a stand-alone chip. In other embodiments, the hybrid accelerators may act as a co-processor requiring a master host to control them.

To minimize the chip area, the hybrid accelerator may include a NVM memory to store network parameters on the chip. Each network parameter may be stored in one or two memory devices in analog form to save even more area. This may eliminate the need to have any costly external memory access.

In some embodiments, the results produced by one accelerator may be directly routed to the input of another accelerator. Skipping the transfer of results to memory may result in further power saving.

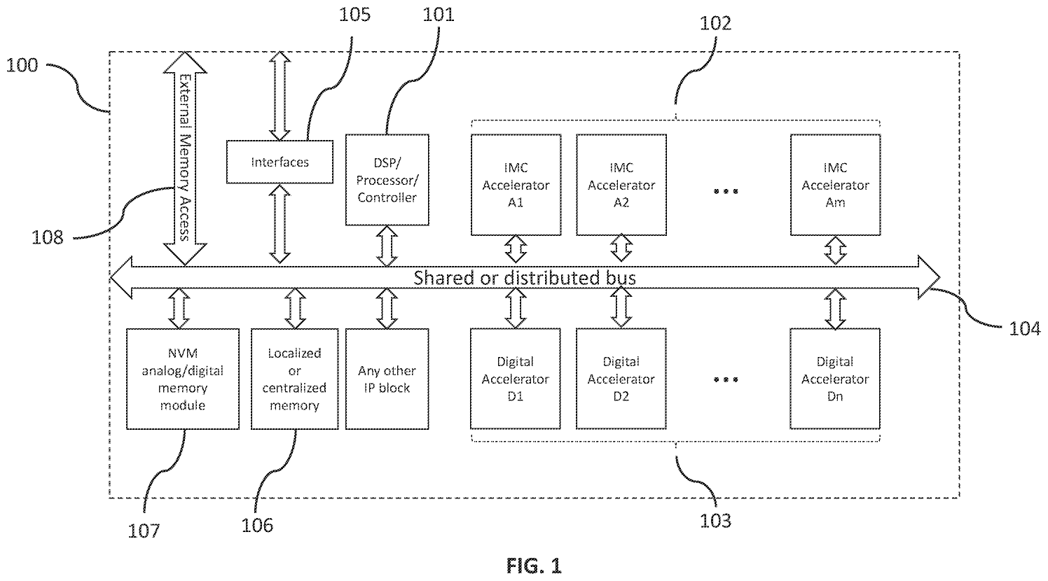

FIG. 1 illustrates an example of a hybrid accelerator 100 consisting of a plurality of digital accelerators 103, a plurality of in-memory computing accelerators 102, connected together and to the main controller/processor 101 through a shared or distributed bus 104. The system may also include other modules required for proper functionality of the system such as interfaces 105, localized or centralized memory 106, NVM analog/digital memory module 107, external memory access bus 108, etc. The hybrid accelerator may be used to accelerate the operation of deep neural networks, machine learning algorithms, etc.

Any digital accelerator (Di) in the plurality of digital accelerators 103 or any IMC accelerator (Ai) in the plurality of IMC accelerators 102 may receive inputs either from an internal memory, such as central memory 106 or an external memory (not shown), or from the processor/controller 101, or directly from an internal memory or buffer of the Di or Ai accelerators and send back the results of the computation either to the internal or external memory, or to the processor/controller 101, or directly to any of the Di or Ai accelerators.

The main software of the host or master controller/processor 101 may distribute the workload of implementing neural networks between digital and in-memory computing accelerators based on the specifications of the layer being implemented. If the layer of neural network being implemented has small number of parameters or has large number of activations resulting in large weight reuse, the software of the host processor may map and implement the layer in the digital accelerators 103 to maximize the system efficiency by minimizing the power consumption. In this case, the weights or parameters of the layer being implemented may be transferred from the internal or external memory to one or multiple digital accelerators 103 and will be kept there for the whole execution of the layer. Then the software or the host processor 101 may send the activation inputs of the layer to the programmed digital accelerators 103 to execute the layer. Since the time and power used to transfer the network parameters to these digital accelerators 103 is negligeable compared to the time and power consumed to transfer activation data or to perform the computations of the layer, implementing these layers in digital accelerators 103 may reach very high efficiency.

The efficiency of digital accelerators 103 may drop if a layer with large number of network parameters or a layer with small reusage of network parameters is implemented in these digital accelerators 103. In these situations, the power consumed by the digital accelerators 103 may be dominated by the power consumed to transfer network parameters from the memory to the accelerator rather than the power consumed to do a useful task like performing the actual computation.

On the other hand, if the layer of neural network being implemented has large number of parameters, the software of the host processor may map and implement the layer in the in-memory computing accelerators 102 to maximize the system efficiency by eliminating the power consumed to move the network parameter over and over around the chip. In this case, the weights or parameters of the layer being implemented may be transferred just once from the internal or external memory and get programmed to one or multiple in-memory computing accelerators 102 and will be kept there forever. Once programmed, these in-memory computing accelerators 102 may be used for the execution of a particular layer. The software or the host processor 101 may send the activation inputs of the layer to the programmed in-memory computing accelerators 102 to execute the layer. Since no time and power will be spent for repeated transfer of network parameters to these in-memory computing accelerators 102, implementing these layers in in-memory computing accelerators 102 may reach very high efficiency.

The efficiency of in-memory computing accelerators 102 may drop if a layer with small number of network parameters is implemented in these accelerators. In these situations, the power consumed by the in-memory computing accelerators 102 may be dominated by the power consumed in peripheral circuitries like ADC and DAC instead of being used to perform a useful task like doing the actual computation.

The software or the host controller 101 may implement the whole neural network by distributing the workload between the digital accelerators 103 and the in-memory computing accelerators 102 to maximize the chip efficiency or minimize its power consumption. The software or the host controller 101 may map the layers of the network which has high weight reuse or small number of network parameters to digital accelerators 103 while layers with large number of parameters are mapped to in-memory computing accelerators 102. In each accelerator group (digital or in-memory computing), multiple accelerators may work together and in parallel to increase the speed and throughput of the chip.

In the hybrid accelerator architecture, different digital or in-memory computing accelerators may perform the computations at the same or different precisions. For example, digital accelerators 103 may perform computations at higher precision than the in-memory computing accelerators 102. Even between all digital accelerators 103, some individual accelerators Di may have higher accuracies than the others. The software or host controller 101, based on the sensitivity of each neural network layer to the accuracy of the computation, may map the layer to specific accelerators meeting the desirable accuracy level while keeping the power consumption as low as possible.

To minimize the costly operation of accessing network parameters from external memory using the external memory access bus 108 or interface module 105, the hybrid architecture may have a small on-chip memory like SRAM to store the weights of the layers of the neural networks which will be implemented on the digital accelerators. In this case, for each inference, the weights may be fetched from the on-chip memory, which may require less power than accessing large external memory.

A NVM memory module 107 may be used to store the weights of the layers of the neural networks which are mapped to digital accelerators 103. While slower than SRAM, these memories may be used to reduce the area of the chip. Area may be reduced further by storing multiple bits of information in each NVM memory cell.

A software or host processor 101 may implement a neural network layer on both digital accelerators 103 and in-memory computing accelerators 102 to speed up the inference and increase the chip throughput with the cost of lowering the chip efficiency.

Digital accelerators 103 may be implemented based on any technology or design architecture like systolic arrays, FPGA-like or reconfigurable architectures, near- or in-memory computing methodologies, etc. They may be based on pure digital circuits or may be implemented based on mixed-signal circuits.

In-memory computing accelerators 102 may be implemented based on any technology or design architecture. They may be implemented using SRAM cells acting as memory devices storing network parameters or they may be using NVM memory device technologies like RRAM, PCM, MRAM, flash, memristors, etc. They may be based on purely digital or analog circuits or may be mixed signal.

The main or host processor/controller 101 managing the operations withing the chip as well as the data movements around the chip may reside within the chip or may be sitting in another chip acting as the master chip controlling the hybrid accelerator.

The digital accelerators 103 or the in-memory computing accelerators 102 may all have the same or different sizes. Having different size accelerators may allow the chip to reach higher efficiencies. In this case, the software or the main controller 101 may implement each layer of the network on the accelerator which has the size closest to the size of the layer being implemented.

The hybrid accelerator 100 may work as a stand-alone chip or may work as a coprocessor controlled with another host processor.

Depending on the technologies used to implement digital and in-memory computing accelerators 103 and 102, these accelerators may or may not be fabricated on a single die. When fabricated on different dies, the accelerators may communicate to each other through an interface.

The software or host processor 101 may pipeline the digital accelerators 103 and in-memory computing accelerators 102 to increase the throughput of the system. In this case, for example while the digital accelerators 103 are implementing the layer Li of the given neural network, in-memory computing accelerators 102 may be executing the computations of layer Li+1. Similar pipelining technique may be implemented between the digital or in-memory computing accelerators 103 and 102 as well to improve the throughput. For example, while the first digital accelerator Di may be implementing the layer Li, the second digital accelerator Di+1 may be implementing layer Li+1, and so on.

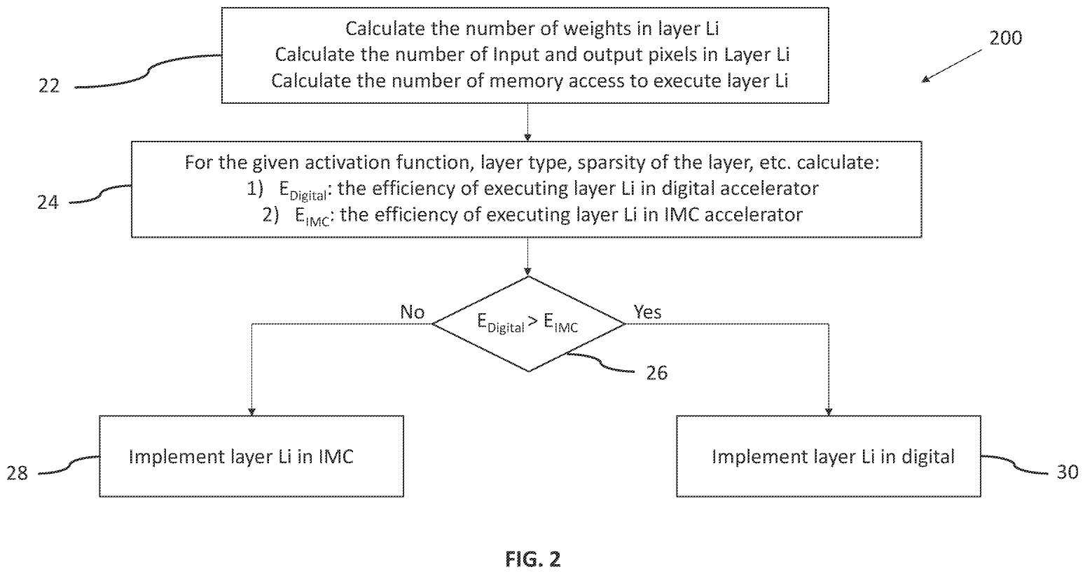

FIG. 2 is a flowchart of an example method 200 for deciding how to map layers of neural networks to digital and in-memory computing accelerators. The method may include, at action 22, calculating the number of weights in layer Li. In this step, for each layer Li in the given neural network, the number of network parameters and the number of times these parameters are reused to do computations on the stream of activation data are calculated. In addition, the required number of memory accesses are also calculated in this step.

The method 200 may include, at action 24, calculating the efficiency of layer Li when implemented in digital accelerators (denoted as E_{Digital}) or in-memory computing accelerators (denoted as E_{IMC}). Using the numbers calculated at action 22 and nominal efficiencies of digital accelerators and in-memory computing accelerators, the software or the main controller may calculate the efficiency of any given layer when implemented in one or multiple digital accelerator and also when it is implemented in one or multiple in-memory computing accelerators.

The method 200, at action 26, may compare the efficiency of implementing layer Li in digital accelerator to the efficiency of implementing layer Li at in-memory computing accelerators. If it is more efficient to implement the layer Li in digital accelerator, the method 200 at action 30 may map this layer to digital accelerators. On the other hand, if the efficiency of implementing the layer in in-memory computing accelerators is higher than digital accelerators, at action 28, the method may map the layer to in-memory computing accelerators.

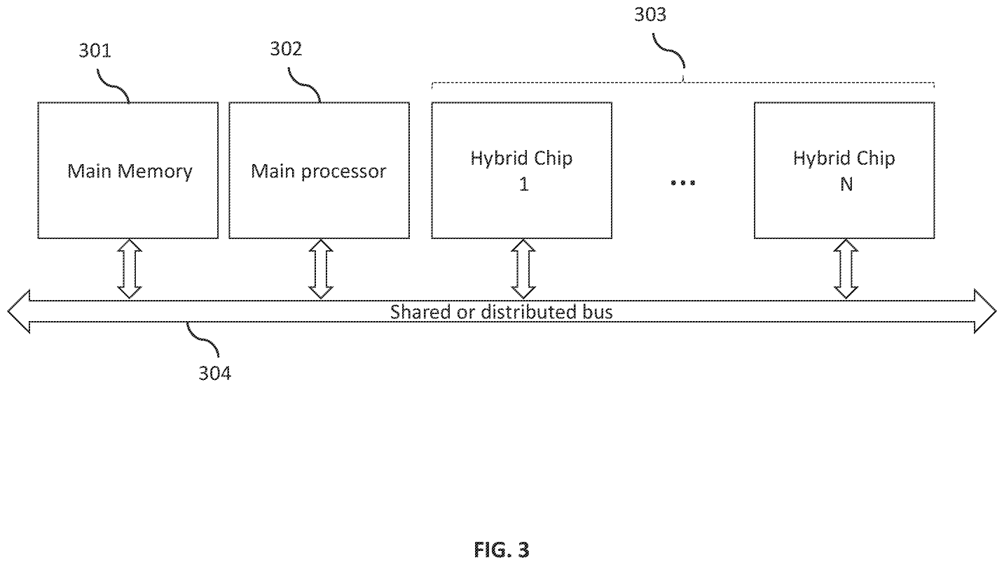

FIG. 3 illustrates an example of the way hybrid accelerators of 100 may be scaled up by connecting them together using a shared or distributed bus 304. In this configuration, the main processor/controller 302 may be controlling all the hybrid accelerators 303, mapping the network layers to different chips, managing the movement of data between the accelerators and the external memory 301 and making sure the system is running smoothly while consuming the least amount of power. The main memory 301 may be an external memory or may be the combination of memories residing inside the hybrid accelerators 303.

In some embodiments, one of the hybrid accelerators may act as a main or master chip substituting the main processor 302 controlling the other hybrid accelerators.

In some embodiments, the main controller may map a single layer of the neural network into multiple hybrid accelerators. In some other embodiments, the main controller may map the same layer into multiple hybrid accelerators to run it in parallel to increase the inference speed. In yet another embodiment, the controller may map different layers of the network on different hybrid accelerators. In addition, the host controller may use multiple accelerators to implement much larger neural network.

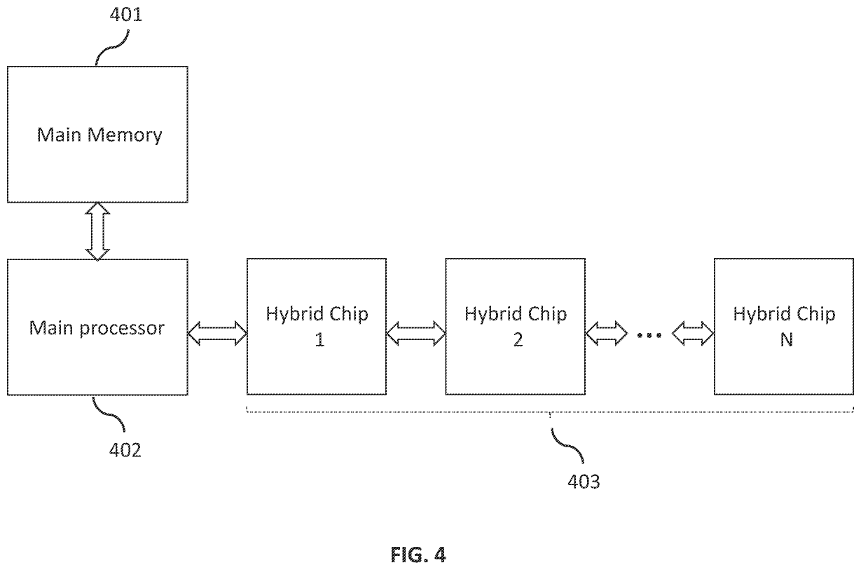

FIG. 4 illustrates an example of the way hybrid accelerators of 100 may be scaled up by daisy chaining multiple hybrid accelerators together. Each of the hybrid accelerators 403 may have direct access to the main memory 401 or indirect access though the main processor 402. The hybrid accelerators 403 may act as a coprocessor controlled by the main processor 402. Commands and data sent by the main processor 402 may be delivered to the targeted hybrid accelerator by each chip passing the data to the next chip.

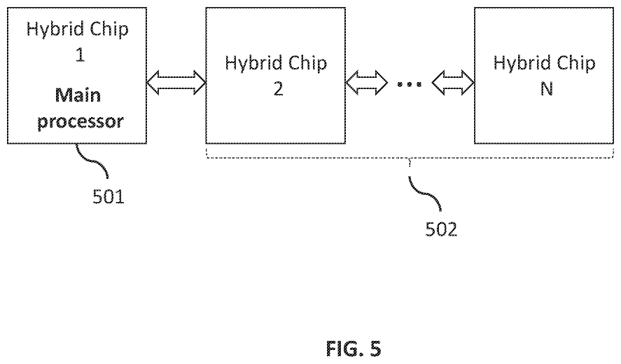

FIG. 5 illustrate another configuration for connecting hybrid accelerators together to scale up the computing system. In this configuration, one of the hybrid accelerators 501 may act as a host or master module controlling the other accelerators 502. The main hybrid accelerator 501 may have the responsibility of managing the data movements and mapping the neural network to different accelerators 502 inside each hybrid accelerators. The communication between the hybrid accelerators and the external memory may be done directly or through the master hybrid chip 501.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. A computer-implemented method for accelerating computations in applications, at least a portion of the method being performed by a computing device comprising one or more processors, the computer-implemented method comprising:
evaluating input data for a computation to identify first data and second data, wherein first data is determined to be more efficiently processed by a digital accelerator and second data is determined to be more efficiently processed by an in-memory computing accelerator;
sending the first data to at least one digital accelerator for processing; and
sending the second data to at least one in-memory computing accelerator for processing.

2. The computer-implemented method of claim 1, wherein:
the computation is evaluated for sensitivity to precision,
the input data for computations determined to require a high level of accuracy is identified as first data, and
the input data for computations determined to tolerate imprecision is identified as second data.

3. The computer-implemented method of claim 1, wherein the input data includes network parameters and activations of a neural network and the computation relates to specific layers of the neural network to be implemented.

4. The computer-implemented method of claim 3, wherein evaluating input data includes calculating a number of network parameters in each layer of the neural network, and wherein the layers of the neural network having a larger number of network parameters are determined to be second data and the layers of the neural network having a smaller number of network parameters are determined to be first data.

5. The computer-implemented method of claim 3, wherein evaluating input data includes calculating a number of times that network parameters are reused in each layer of the neural network, and wherein the layers of the neural network having a high weight of network parameter reuse are determined to be first data and the layers of the neural network having a low weight of network parameter reuse are determined to be second data.

6. The computer-implemented method of claim 3, wherein the at least one digital accelerator and the at least one in-memory computing accelerator are configured to implement the same layer of the neural network.

7. The computer-implemented method of claim 1, wherein:
the at least one digital accelerator includes a first digital accelerator located on a first hybrid chip and a second digital accelerator located on a second hybrid chip,
the at least one in-memory computing accelerator includes a first in-memory computing accelerator located on the first hybrid chip and a second in-memory computing accelerator located on the second hybrid chip, and
the first and second hybrid chips are connected together by a shared bus or through a daisy chain connection.

8. One or more non-transitory computer-readable media comprising one or more computer-readable instructions that, when executed by one or more processors of a security server, cause the security server to perform a method for accelerating computations in applications, the method comprising:
evaluating input data for a computation to identify first data and second data, wherein first data is determined to be more efficiently processed by a digital accelerator and second data is determined to be more efficiently processed by an in-memory computing accelerator;
sending the first data to at least one digital accelerator for processing; and
sending the second data to at least one in-memory computing accelerator for processing.

9. The one or more non-transitory computer-readable media of claim 8, wherein:
the computation is evaluated for sensitivity to precision,
the input data for computations determined to require a high level of accuracy is identified as first data, and
the input data for computations determined to tolerate imprecision is identified as second data.

10. The one or more non-transitory computer-readable media of claim 8, wherein the input data includes network parameters of a neural network and the computation relates to specific layers of the neural network to be implemented.

11. The one or more non-transitory computer-readable media of claim 10, wherein evaluating input data includes calculating a number of network parameters in each layer of the neural network, and wherein the layers of the neural network having a larger number of network parameters are determined to be second data and the layers of the neural network having a smaller number of network parameters are determined to be first data.

12. The one or more non-transitory computer-readable media of claim 10, wherein evaluating input data includes calculating a number of times that network parameters are reused in each layer of the neural network, and wherein the layers of the neural network having a high weight of network parameter reuse are determined to be first data and the layers of the neural network having a low weight of network parameter reuse are determined to be second data.

13. The one or more non-transitory computer-readable media of claim 10, wherein the at least one digital accelerator and the at least one in-memory computing accelerator are configured to implement the same layer of the neural network.

14. The one or more non-transitory computer-readable media of claim 8, wherein:
the at least one digital accelerator includes a first digital accelerator located on a first hybrid chip and a second digital accelerator located on a second hybrid chip,
the at least one in-memory computing accelerator includes a first in-memory computing accelerator located on the first hybrid chip and a second in-memory computing accelerator located on the second hybrid chip, and
the first and second hybrid chips are connected together by a shared bus or through a daisy chain connection.

15. A system for accelerating computations in applications, the system comprising:
a memory storing programmed instructions;
at least one digital accelerator;
at least one in-memory computing accelerator; and
a processor configured to execute the programmed instructions to:
evaluate input data for a computation to identify first data and second data, wherein first data is determined to be more efficiently processed by the at least one digital accelerator and second data is determined to be more efficiently processed by the at least one in-memory computing accelerator;
send the first data to the at least one digital accelerator for processing; and
send the second data to the at least one in-memory computing accelerator for processing.

16. The system of claim 15, wherein:
the computation is evaluated for sensitivity to precision,
the input data for computations determined to require a high level of accuracy is identified as first data, and
the input data for computations determined to tolerate imprecision is identified as second data.

17. The system of claim 15, wherein the input data includes network parameters of a neural network and the computation relates to specific layers of the neural network to be implemented.

18. The system of claim 17, wherein evaluating input data includes calculating a number of network parameters in each layer of the neural network, and wherein the layers of the neural network having a larger number of network parameters are determined to be second data and the layers of the neural network having a smaller number of network parameters are determined to be first data.

19. The system of claim 17, wherein evaluating input data includes calculating a number of times that network parameters are reused in each layer of the neural network, and wherein the layers of the neural network having a high weight of network parameter reuse are determined to be first data and the layers of the neural network having a low weight of network parameter reuse are determined to be second data.

20. The system of claim 15, wherein:
the at least one digital accelerator includes a first digital accelerator located on a first hybrid chip and a second digital accelerator located on a second hybrid chip,
the at least one in-memory computing accelerator includes a first in-memory computing accelerator located on the first hybrid chip and a second in-memory computing accelerator located on the second hybrid chip, and
the first and second hybrid chips are connected together by a shared bus or through a daisy chain connection.
